(19) United States
(12) Patent Application Publication
(10) Pub. No.: US 2013/0265858 A1
(43) Pub. Date: Oct. 10, 2013

(54) ALARM CLOCK SYSTEM AND CELLPHONE HAVING SAME

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: REN-WEN HUANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/854,154

(22) Filed: Apr. 1, 2013

(30) Foreign Application Priority Data
Apr. 5, 2012 (CN) 201210097114.3

(51) Int. Cl. G04G 13/02

(52) U.S. Cl. CPC G04G 13/026
USPC 368/4; 368/73

(57) ABSTRACT

An alarm clock system includes an alarm clock setting module, an alarm clock recording module, an alarm clock studying module, a controlling module and an alarm clock. The alarm clock setting module allows a user to set alarm times at which the alarm clock is activated. The alarm clock recording module records the alarm times set by the user during a time period. The alarm clock studying module analyzes the alarm times to determine a regular repeated pattern of the alarm times and a period of the repeated pattern. The controlling module controls the alarm clock setting module to automatically set alarm times for following days in a subsequent period according to the determined pattern of the alarm times and the period of the repeated pattern. A cellphone employing the alarm clock system is also described.

### BACKGROUND

1. Technical Field

The present disclosure relates to an alarm clock system and a cellphone having same.

2. Description of the Related Art

An alarm clock program in mobile phones can be used to wake up a user. The mobile phone can set only one alarm time, and if the user needs to periodically change the alarm time, the user must manually change the alarm time, this is inconvenient.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagram block of an alarm clock system, according to an exemplary embodiment.

FIG. 2 is a diagram block of a cellphone, according to an exemplary embodiment.

### DETAILED DESCRIPTION

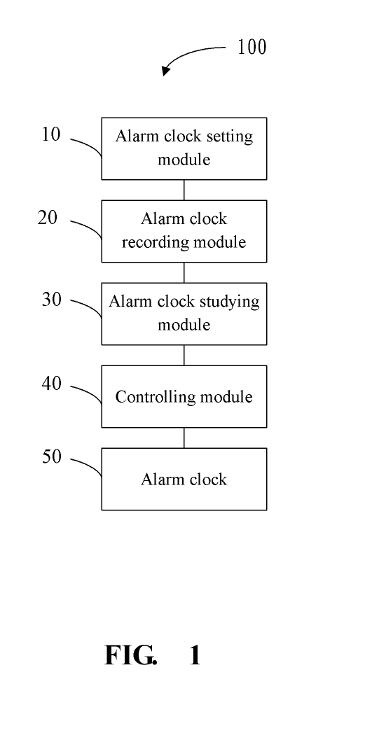

FIG. 1 shows an alarm clock system 100 of an embodiment. The alarm clock system 100 includes an alarm clock setting module 10, an alarm clock recording module 20, an alarm clock studying module 30, a controlling module 40 and an alarm clock 50. The alarm clock setting module 10 allows a user to set alarm times or points at which the alarm clock is activated. The alarm clock recording module 20 records the alarm times set by the user during time period. The alarm clock studying module 30 analyzes the alarm times to determine a regular repeated pattern of the alarm times and a period of the regular repeated pattern. For example, the alarm times set by the user are 7:00 am from Monday to Friday and 9:00 am on Saturday and Sunday in just the past two weeks. According to the above user set alarm times, the alarm clock studying module 30 determines the alarm times of 7:00 am on the five weekdays and the alarm times of 9:00 am on Saturday and Sunday, and determines one week as a period. The controlling module 40 controls the alarm clock setting module 10 to automatically set alarm times for following days in a subsequent period according to the pattern of the alarm times and the period of the repeated pattern. The controlling module 40 further sends an alarm clock instruction to the alarm clock 50 when the passage of time is the same as an alarm time. The alarm clock 50 turns on an alarm according to the alarm clock instruction.

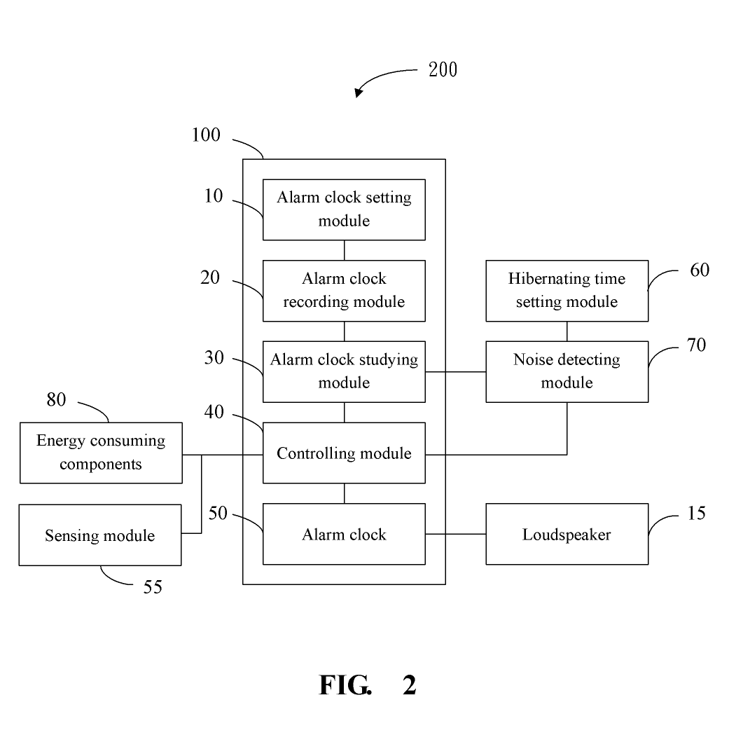

FIG. 2 shows a cellphone 200 of an embodiment. The cellphone 200 employs the alarm clock system 100. The cellphone 200 includes a loudspeaker 15, a hibernating time setting module 60 and a noise detecting module 70. The loudspeaker 15 plays sound when the alarm clock 50 is active. The hibernating time setting module 60 allows a user to set a hibernating time period during which the cellphone 200 operates in a hibernating mode. The hibernating time period ends at one of the alarm times. The noise detecting module 70 detects ambient noise at the beginning of the hibernating time period. For example, the alarm clock time is 6:00 am and the hibernating time period is seven hours. According to the alarm time and hibernating time period, the noise detecting module 70 detects ambient noise at the beginning of 11:00 pm. If the level of the detected noise is less than a preset value, the controlling module 40 turns off all the energy consuming components 80 of the cellphone 200 except for minimum modules thereof that are required to sustain normal operation of the alarm clock. When a time reaches the alarm time, the controlling module 40 further turns on any energy consuming components 80 which have been turned off during the previous hibernating time period.

In alternative exemplary embodiment, the cellphone 200 further includes a sensing module 55. The sensing module 55 senses any operations by the user to the cellphone 200 at the beginning of the hibernating time period. If the sensing module 55 senses no user operations to the cellphone 200 and the level of the detected noise is less than the preset value at the beginning of the hibernating time period, the controlling module 40 turns off all the energy consuming components 80 of the cellphone 200 except for minimum modules thereof that are required to sustain normal operation of the alarm clock.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An alarm clock system comprising:
an alarm clock;
an alarm clock setting module for allowing a user to set alarm times at which the alarm clock is activated;
an alarm clock recording module for recording the alarm times set by the user during a time period;
an alarm clock studying module for analyzing the alarm times to determine a regular repeated pattern of the alarm times and a period of the repeated pattern; and
a controlling module for controlling the alarm clock setting module to automatically set alarm times for following days in a subsequent period according to the determined pattern of the alarm times and the period of the repeated pattern.

2. A cellphone comprising:
a loudspeaker;
an alarm clock;
an alarm clock setting module for allowing a user to set alarm times at which the alarm clock is activated to drive the loudspeaker to play sound;
an alarm clock recording module for recording the alarm times set by the user during a time period;
an alarm clock studying module for analyzing the alarm times to determine a regular repeated pattern of the alarm times and a period of the repeated pattern; and
a controlling module for controlling the alarm clock setting module to automatically set alarm times for following days in a subsequent period according to the determined pattern of the alarm times and the period of the repeated pattern.

3. The cellphone as claimed in claim 2, further comprising:
a hibernating time setting module configured to allow a user to set a hibernating time period during which the cellphone operates in a hibernating mode, the hibernating time period ending at one of the alarm times; and
a noise detecting module configured to detect ambient noise at the beginning of the hibernating time period;
wherein the controlling module configured to turn off all the energy consuming components of the cellphone except for minimum modules thereof that are required to sustain normal operation of the alarm clock if a level of the detected noise is less than a preset value at the beginning of the hibernating time period.

4. The cellphone as claimed in claim 3, further comprising a sensing module, the sensing module senses any operations by the user to the cellphone at the beginning of the hibernating time period, if the sensing module senses no user operations to the cellphone and the level of the detected noise is less than the preset value at the beginning of the hibernating time period, the controlling module turns off all the energy consuming components of the cellphone except for minimum modules thereof that are required to sustain normal operation of the alarm clock.
